(19) United States
(12) Patent Application Publication
(10) Pub. No.: US 2016/0001506 A1
(43) Pub. Date: Jan. 7, 2016

(54) METHOD OF MANUFACTURING THREE-DIMENSIONAL STRUCTURE, THREE-DIMENSIONAL STRUCTURE, AND THREE-DIMENSION FORMATION COMPOSITION

(71) Applicant: SEIKO EPSON CORPORATION, Tokyo (JP)

(72) Inventors: Koki HIRATA, Matsumoto (JP); Hiroshi FUKUMOTO, Shiojiri (JP); Shinichi KATO, Matsumoto (JP); Chigusa SATO, Shiojiri (JP)

(21) Appl. No.: 14/754,910

(22) Filed: Jun. 30, 2015

(30) Foreign Application Priority Data
Jul. 2, 2014 (JP) 2014-137111
Apr. 10, 2015 (JP) 2015-080920

(51) Int. Cl. B29C 67/00; C08L 33/02; C08L 33/26; C08L 5/04; C08L 25/18; C08L 97/00; C08L 45/00; C08L 1/28

(52) U.S. Cl. CPC B29C 67/0081; C08L 45/00; C08L 33/02; C08L 1/286; C08L 5/04; C08L 25/18; C08L 97/005; C08L 33/26; B33Y 80/00

(57) ABSTRACT

There is provided a method of manufacturing a three-dimensional structure, in which the three-dimensional structure is manufactured by laminating a layer, the method including: forming the layer using a three-dimension formation composition containing particles, a binding resin, and a solvent; applying a binding solution containing a binder to the layer; and removing the particles, which are not bound by the binder, using a removing solution after repeating the forming of the layer and the applying of the binding solution, in which, in the removing of the unbound particles, the binding resin has a water-soluble functional group whose pKa in water is less than the pH of the removing solution.

### BACKGROUND

1. Technical Field

The present invention relates to a method of manufacturing a three-dimensional structure, a three-dimensional structure, and a three-dimension formation composition.

2. Related Art

A technology of forming a three-dimensional object while hardening powder with a binding solution is known (for example, refer to JP-A-2011-245712). In this technology, a three-dimensional object is formed by repeating the following operations. First, a slurry containing powder particles, a water-based solvent and a water-soluble polymer is thinly spread in a uniform thickness to form a layer, and a binding solution is discharged onto a desired portion of the layer to bind the powder particles together. As a result, in the layer, only the portion onto which the binding solution is discharged is attached to form a thin plate-like member (hereinafter referred to as “section member”). Thereafter, a layer is further formed on this layer, and a binding solution is discharged to a desired portion thereof. As a result, a new section member is formed even on the portion of the newly-formed layer to which the binding solution is discharged. In this case, since the binding solution discharged on the layer penetrates this layer to reach the previously-formed section member, the newly-formed section member is attached to the previously-formed section member. The thin plate-like section members are laminated one by one by repeating these operations, and then the unbound particles are removed, thereby forming a three-dimensional object.

In this technology of forming a three-dimensional object, when three-dimensional shape data of an object to be formed exists, it is possible to directly form a three-dimensional object by binding powder particles, and there is no need to create a mold prior to formation, so that it is possible to quickly and inexpensively form a three-dimensional object. In addition, since the three-dimensional object is formed by laminating the thin plate-like section members one by one, for example, even in the case of a complex object having a complicated internal structure, it is possible to form the three-dimensional object as an integrally-formed structure without dividing the complex object into a plurality of parts.

However, in the related art, it is difficult to easily remove the unbound powder particles. Therefore, a three-dimensional structure cannot be efficiently manufactured.

### SUMMARY

An advantage of some aspects of the invention is to provide a method of manufacturing a three-dimensional structure, by which a three-dimensional structure can be efficiently manufactured, and a three-dimension formation composition, and to provide a high-quality three-dimensional structure.

The invention is realized in the following forms.

According to an aspect of the invention, there is provided a method of manufacturing a three-dimensional structure, in which the three-dimensional structure is manufactured by laminating a layer, the method including: forming the layer using a three-dimension formation composition containing particles, a binding resin, and a solvent; applying a binding solution containing a binder to the layer; and removing the particles, which are not bound by the binder, using a removing solution after repeating the forming of the layer and the applying of the binding solution, in which, in the removing of the unbound particles, the binding resin has a water-soluble functional group whose pKa in water is less than the pH of the removing solution.

In this case, it is possible to provide a method of manufacturing a three-dimensional structure which can efficiently manufacture a three-dimensional structure.

In the method of manufacturing a three-dimensional structure according to the aspect of the invention, it is preferable that the pKa of the water-soluble functional group in water is 6 or less.

In this case, it is possible to allow unbound particles to be more easily removed by a safe and versatile removing solution, such as water.

In the method of manufacturing a three-dimensional structure according to the aspect of the invention, it is preferable that the water-soluble functional group is a carboxyl group or a sulfo group.

In this case, it is possible to allow particles, which are not bound by a binder, to be more easily removed.

In the method of manufacturing a three-dimensional structure according to the aspect of the invention, it is preferable that the binding resin having a carboxyl group as the water-soluble functional group contains one or more selected from the group consisting of a reaction product of an olefin-maleic anhydride copolymer with ammonia, polyacrylic acid, carboxymethyl cellulose, polystyrene carboxylic acid, a acrylamide-acrylic acid copolymer, and alginic acid, and salts thereof.

In this case, it is possible to further improve the binding force of the binding resin, and, in the removing of the unbound particles, it is possible to more efficiently remove the unbound particles (unnecessary portion).

In the method of manufacturing a three-dimensional structure according to the aspect of the invention, it is preferable that the binding resin having a sulfo group as the water-soluble functional group contains lignin sulfonic acid or a salt thereof.

In this case, it is possible to further improve the binding force of the binding resin, and, in the removing of the unbound particles, it is possible to more efficiently remove the unbound particles (unnecessary portion).

In the method of manufacturing a three-dimensional structure according to the aspect of the invention, it is preferable that the weight average molecular weight of the binding resin in the three-dimension formation composition is 50000 to 200000.

In this case, it is possible to more efficiently remove the unbound particles in the removing of the unbound particles, it is possible to further improve the dimensional accuracy of the three-dimensional structure, and it is possible to make the productivity of the three-dimensional structure particularly excellent.

In the method of manufacturing a three-dimensional structure according to the aspect of the invention, it is preferable that, in the applying of the binding solution, the binding resin has a structure of acid anhydride, and, in the removing of the unbound particles, the binding resin has a structure of an ammonium salt of a carboxyl group and has an amide group (—CONH₂).

In this case, it is possible to make the productivity of the three-dimensional structure more excellent, and it is possible to more reliably make the dimensional accuracy and mechanical strength of the three-dimensional structure particularly excellent. Further, when heat treatment is carried out as post-treatment after the removing of the unbound particles, it is possible to suitably separate ammonia from the binding resin, and thus it is possible to make the water resistance of the three-dimensional structure more excellent.

In the method of manufacturing a three-dimensional structure according to the aspect of the invention, it is preferable that, in the applying of the binding solution, the binding resin has a cyclic chemical structure, and, in the removing of the unbound particles, the cyclic chemical structure of the binding resin is ring-opened.

In this case, it is possible to make the productivity of the three-dimensional structure more excellent, and it is possible to more reliably make the dimensional accuracy and mechanical strength of the three-dimensional structure particularly excellent.

In the method of manufacturing a three-dimensional structure according to the aspect of the invention, it is preferable that the cyclic chemical structure is a five-membered or six-membered cyclic structure.

In this case, it is possible to make the productivity, dimensional accuracy and mechanical strength of the three-dimensional structure more excellent.

According to another aspect of the invention, there is provided a three-dimensional structure, which is manufactured by the method of manufacturing a three-dimensional structure of the invention.

In this case, it is possible to provide a high-quality three-dimensional structure.

According to still another aspect of the invention, there is provided a three-dimension formation composition, which is used in the method of manufacturing a three-dimensional structure of the invention, the composition including: particles; a binding resin; and a solvent, in which, in the removing of the unbound particles, the binding resin has a water-soluble functional group whose pKa in water is less than the pH of the removing solution.

In this case, it is possible to provide a three-dimension formation composition which can efficiently manufacture a three-dimensional structure.

### BRIEF DESCRIPTION OF THE DRAWINGS

The invention will be described with reference to the accompanying drawings, wherein like numbers reference like elements.

FIGS. 1A to 1D are schematic views showing each process of a preferred embodiment in a method of manufacturing a three-dimensional structure of the invention.

FIGS. 2A to 2D are schematic views showing each process of a preferred embodiment in a method of manufacturing a three-dimensional structure of the invention.

FIG. 3 is a flowchart showing an example of the method of manufacturing a three-dimensional structure of the invention.

FIG. 4 is a perspective view showing the shape of a three-dimensional structure (three-dimensional structure A) manufactured in each of Examples and Comparative Examples.

FIG. 5 is a perspective view showing the shape of a three-dimensional structure (three-dimensional structure B) manufactured in each of Examples and Comparative Examples.

### DESCRIPTION OF EXEMPLARY EMBODIMENTS

Hereinafter, preferred embodiments of the invention will be described in detail with reference to the accompanying drawings.

### 1. Method of Manufacturing Three-Dimensional Structure

First, a method of manufacturing a three-dimensional structure according to the invention will be described.

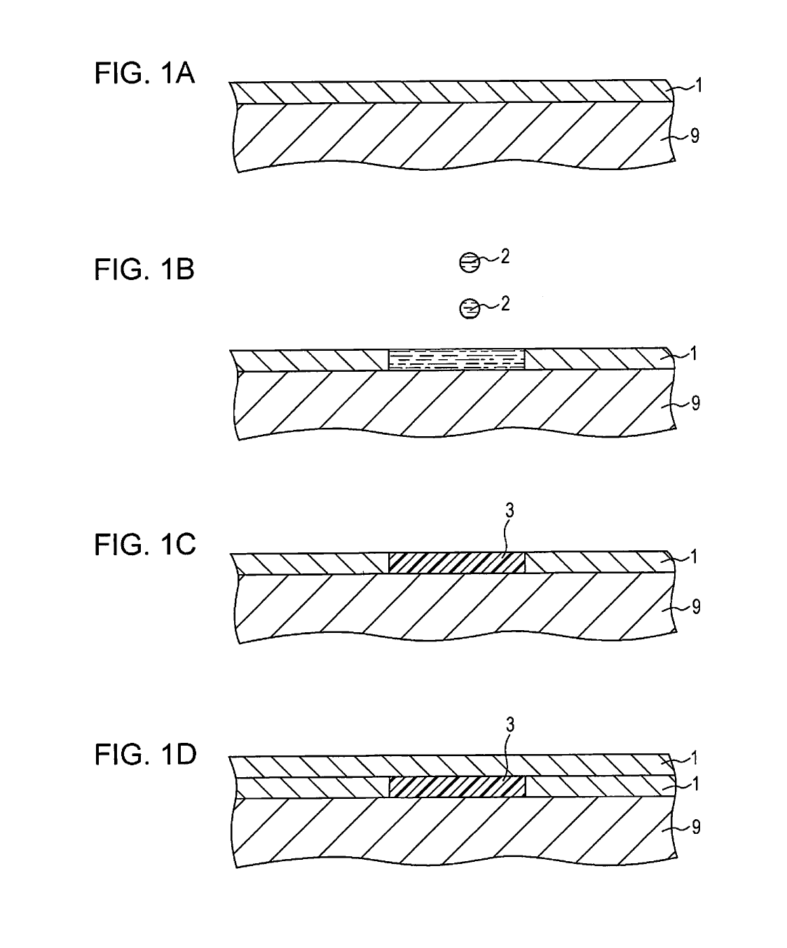

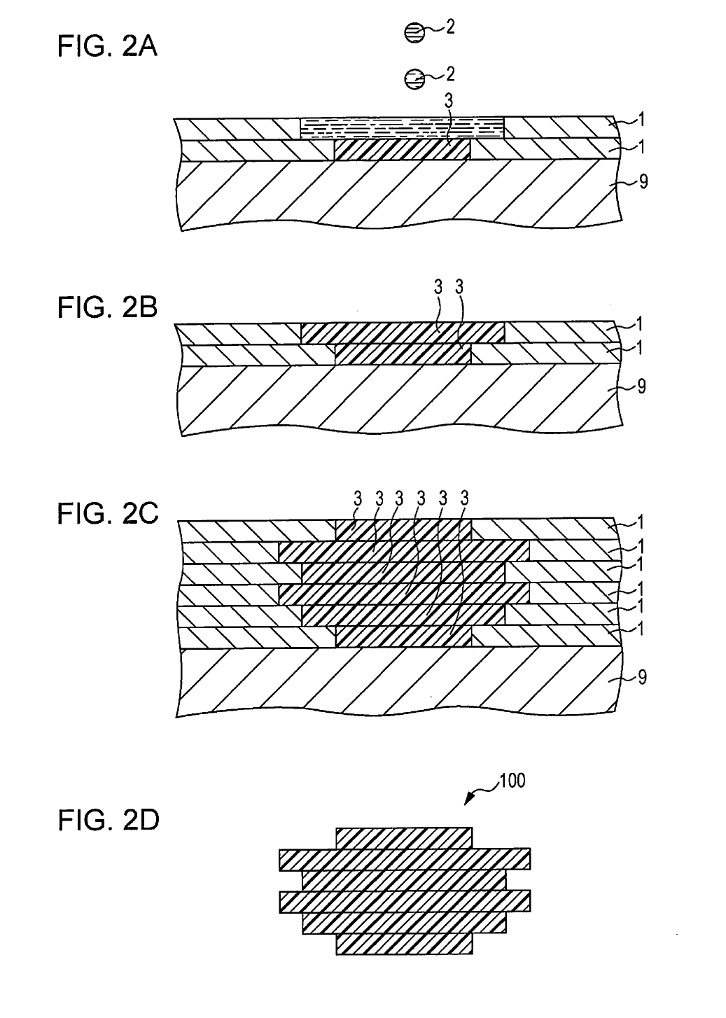

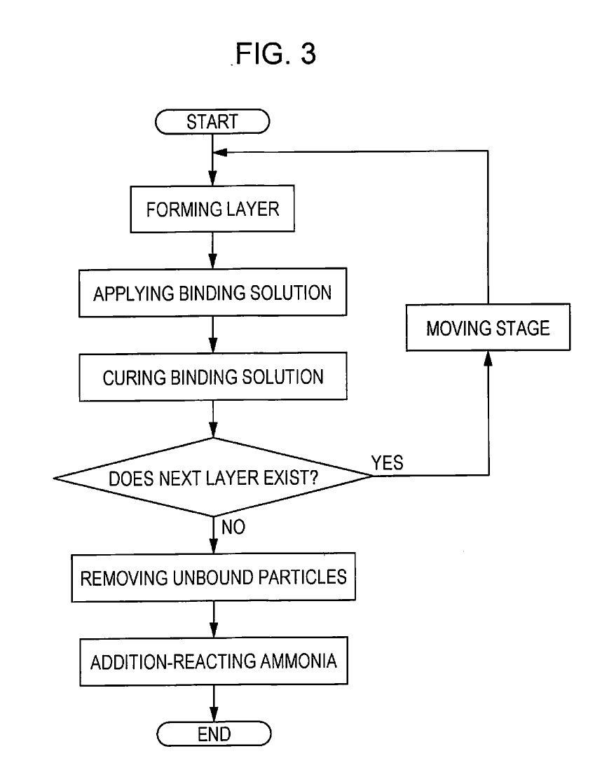

FIGS. 1A to 2D are schematic views showing each process of a preferred embodiment in the method of manufacturing a three-dimensional structure of the invention. FIG. 3 is a flowchart showing an example of the method of manufacturing a three-dimensional structure of the invention.

As shown in FIGS. 1A to 2D, the method of manufacturing a three-dimensional structure according to the present embodiment includes: layer forming processes (1A and 1D) of forming layers 1 using a three-dimension formation composition containing particles, a binding resin, and a solvent; a binding solution application processes (1B and 2A) of applying a binding solution 2 containing a binder to each of the layers 1 by an ink jet method; and curing processes (1C and 2B) of curing the binder contained in the binding solution 2 applied to each of the layers 1. Here, these processes are sequentially repeated (2C). The method of manufacturing a three-dimensional structure further includes an unbound particle removal process (2D) of removing particles, which are not bound by the binder, from the particles constituting each of the layers 1.

### Layer Forming Process

First, a layer 1 is formed on a support (stage) 9 using a three-dimension formation composition containing particles, a binding resin, and a solvent (1A).

The support 9 has a flat surface (site on which the three-dimension formation composition is applied). Thus, it is possible to easily and reliably form the layer 1 having high thickness uniformity.

It is preferable that the support 9 is made of a high-strength material. Various kinds of metal materials, such as stainless steel and the like, are exemplified as the constituent material of the support 9.

In addition, the surface (site on which the three-dimension formation composition is applied) of the support 9 may be surface-treated. Thus, it is possible to effectively prevent the constituent material of the three-dimension formation composition or the constituent material of the binding solution 2 from adhering to the support 9, and it is also possible to realize the stable production of a three-dimensional structure 100 over a long period of time by making the durability of the support 9 particularly excellent. As the material used in the surface treatment of the support 9, a fluorine-based resin, such as polytetrafluoroethylene, is exemplified.

The three-dimension formation composition contains particles, a binding resin, and a solvent.

By allowing the three-dimension formation composition to contain the binding resin, the particles are bound (temporarily fixed) together to effectively prevent the involuntary scattering of the particles. Thus, it is possible to improve the safety of workers or the dimensional accuracy of the three-dimensional structure 100 which is manufactured.

The three-dimension formation composition will be described in detail later.

This process can be performed using a squeegee method, a screen printing method, a doctor blade method, a spin coating method, or the like.

The thickness of the layer 1 formed in this process is not particularly limited, but is preferably 10 μm to 100 μm, and more preferably 10 μm to 50 μm. Thus, the productivity of the three-dimensional structure 100 can be sufficiently increased, the occurrence of involuntary unevenness in the manufactured three-dimensional structure 100 can be more effectively prevented, and the dimensional accuracy of the three-dimensional structure 100 can be particularly increased.

### Binding Solution Application Process

Thereafter, a binding solution 2 containing a binder is applied to the layer 1 by an ink jet method (1B).

In this process, the binding solution 2 is selectively applied to only the site corresponding to the real part (substantial site) of the three-dimensional structure 100 in the layer 1.

In this process, since the binding solution 2 is applied by an ink jet method, the binding solution 2 can be applied with good reproducibility even when the pattern of the applied binding solution 2 has a fine shape. As a result, it is possible to make the dimensional accuracy of the finally obtained three-dimensional structure 100 particularly high.

The binding solution 2 will be described in detail later.

### Curing Process

Next, the binding solution applied to the layer 1 is cured to form a cured portion 3 (1C). Thus, binding strength between the particles can be made particularly excellent, and, as a result, the mechanical strength or water resistance of the finally obtained three-dimensional structure 100 can be made particularly excellent.

Although differing depending on the kind of a curing component (binder), for example, when the curing component (binder) is a thermosetting component, this process can be performed by heating, and, when the curing component (binder) is photocurable component, this process can be performed by irradiation of the corresponding light (for example, this process can be performed by irradiation of ultraviolet rays when the curing component is an ultraviolet-curable component). Further, this curing process is unnecessary depending on the kind of binder.

The binding solution application process and the curing process may be simultaneously performed. That is, the curing reaction may sequentially proceed from the site on which the binding solution 2 is applied, before the entire pattern of one entire layer 1 is formed.

Thereafter, a series of the processes are repeated (refer to 1D, 2A, and 2B). Thus, in each of the layers 1, the particles are bound on the site on which the binding solution 2 has been applied, and, in this state, a three-dimensional structure 100 is obtained as a laminate in which the plurality of layers 1 are laminated (refer to 2C).

In the second and subsequent binding solution application processes (refer to 2A), the binding solution 2 applied on the layer 1 is used in binding the particles constituting this layer 1, and a part of the applied binding solution 2 adheres closely to the layer 1 located under this layer 1. For this reason, the binding solution 2 is used in binding the particles between adjacent layers as well as binding the particles in each of the layers 1. As a result, the finally obtained three-dimensional structure 100 becomes excellent in mechanical strength as a whole.

### Unbound Particle Removal Process

After the above-mentioned series of processes are repeated, in the particles constituting each of the layers 1, the unbound particle removal process (2D) of removing the particles (unbound particles) not bound by the binder is performed. Thus, a three-dimensional structure 100 is obtained.

In this process, specifically, unbound particles are removed using a removing solution.

As described above, the three-dimension formation composition used in forming the layer 1 contains the binding resin. However, in this process, this binding resin has a water-soluble functional group whose pKa in water is less than the pH of the removing solution.

For this reason, the binding resin can be easily dissolved by the removing solution, and thus unbound particles can be easily removed. As a result, it is possible to efficiently manufacture the three-dimensional structure. Further, since unbound particles can be easily removed, it is possible to effectively prevent the three-dimensional structure from being damaged at the time of removing unbound particles, and thus it is possible to provide a high-quality three-dimensional structure. Particularly, even when a targeted three-dimensional structure has a shape, such as width-narrow recess, depth-deep recess, or curved or bent recess, by which unbound particles (unnecessary portion) are less likely to be sufficiently removed by a mechanical method, it is possible to efficiently and sufficiently remove unbound particles (unnecessary portion).

For example, when performing the removal of unbound particles using a removing solution having a pH of 6 to 8 (for example, a neutral removing solution such as water, saline water, or the like), in this process, a binding resin having a water-soluble functional group of a pKa of 2 to 3 is used, thereby easily removing unbound particles. An example of the water-soluble functional group of a pKa of 2 to 3 includes a sulfo group.

Further, when performing the removal of unbound particles using a removing solution having a pH of 8.5 or more (for example, an alkaline removing solution such as ammonia water, lime water, a sodium hydroxide solution, a sodium hydrogen carbonate solution, or the like), in this process, a binding resin having a water-soluble functional group of a pKa of 5.5 to 6.5 is used, thereby easily removing unbound particles. An example of the water-soluble functional group of a pKa of 5.5 to 6.5 includes a carboxyl group. In the case of a carboxyl group, a removing solution having a pH of 6 to 8 (for example, a neutral removing solution such as water, saline water, or the like) can be used.

Particularly, when an ammonia-containing liquid is used as the removing solution in this process, the following effects are obtained. That is, when the binding resin contained in the three-dimension formation composition used in the formation of the layer 1, as described later, causes a elimination reaction of ammonia after the layer forming process, an ammonia-containing liquid is used as the removing solution in this process, thereby proceeding the addition reaction of adding ammonia to the binder resin. Thus, the water-soluble functional group lost by the elimination reaction can be introduced again into the binding resin. Meanwhile, even when the binding resin contained in the three-dimension formation composition does not contain a water-soluble functional group and even when the water-soluble functional group satisfying the above-mentioned condition of pKa can be produced by a reaction with ammonia, the same effect as described above can be obtained.

Examples of specific methods used in this process include a method of dipping the laminate obtained as described above into the removing solution, a method of imparting vibration such as ultrasonic vibration in a state of the laminate being dipped into the removing solution, and a method of blowing the removing solution.

In the case of using the removing solution, it is preferable that this process is carried out while heating the laminate.

Thus, removal efficiency of unbound particles (unnecessary portion) can be made particularly excellent. Particularly, even when a targeted three-dimensional structure, for example, is the above mentioned three-dimensional structure having a recess, the viscosity of the removing solution is lowered by heating, and thus the removing solution can easily permeate into the recess. As a result, even when the targeted three-dimensional structure has a shape, by which unbound particles (unnecessary portion) are less likely to be sufficiently removed, it is possible to efficiently and sufficiently remove unbound particles (unnecessary portion).

Treatment temperature in this process is not particularly limited, but is preferably 20° C. to 100° C., and more preferably 25° C. to 80° C.

Thus, it is possible to make the removal efficiency of unbound particles (unnecessary portion) particularly excellent while effectively preventing the involuntary denaturation and degradation of the constituent material of the three-dimensional structure 100.

The above-mentioned method of manufacturing a three-dimensional structure is summarized in the flowchart shown in FIG. 3.

According to the above-mentioned method of manufacturing a three-dimensional structure of the invention, it is possible to efficiently manufacture a three-dimensional structure.

### 2. Three-Dimension Formation Composition

Next, a three-dimension formation composition will be described in detail.

The three-dimension formation composition contains a plurality of particles, a binding resin, and a solvent.

Hereinafter, each component will be described in detail.

### Particle

The three-dimension formation composition contains particles.

As the constituent materials of the particles, for example, inorganic materials, organic materials, and complexes thereof are exemplified.

As the inorganic material constituting the particle, for example, various metals and metal compounds are exemplified. Examples of the metal compounds include: various metal oxides, such as silica, alumina, titanium oxide, zinc oxide, zirconium oxide, tin oxide, magnesium oxide, and potassium titanate; various metal hydroxides, such as magnesium hydroxide, aluminum hydroxide, and calcium hydroxide; various metal nitrides, such as silicon nitride, titanium nitride, and aluminum nitride; various metal carbides, such as silicon carbide and titanium carbide; various metal sulfides, such as zinc sulfide; various metal carbonates, such as calcium carbonate and magnesium carbonate; various metal sulfates, such as calcium sulfate and magnesium sulfate; various metal silicates, such as calcium silicate and magnesium silicate; various metal phosphates, such as calcium phosphate; various metal borates, such as aluminum borate and magnesium borate; complexes thereof; and gypsum (each hydrate of calcium sulfate, anhydride of calcium sulfate, and the like).

As the organic material constituting the particle, synthetic resins and natural polymers are exemplified. Specific examples of the organic material include polyethylene resins; polypropylene; polyethylene oxide; polypropylene oxide; polyethylene imine; polystyrene; polyurethane; polyurea; polyester; silicone resins; acrylic silicone resins; a polymer containing (meth)acrylic ester as a constituent monomer, such as polymethyl methacrylate; a crosspolymer (ethylene-acrylic acid copolymer resin or the like) containing (meth)acrylic ester as a constituent monomer, such as methyl methacrylate crosspolymer; polyamide resins, such as nylon 12, nylon 6 and copolymerized nylon; polyimide; carboxymethyl cellulose; gelatin; starch; chitin; chitosan; and polycarbonates.

Among these, the particle is preferably made of an inorganic material, more preferably made of a metal oxide, and further preferably made of silica. Thus, it is possible to make the characteristics, such as mechanical strength and light resistance, of the three-dimensional structure 100 particularly excellent. Further, due to excellent fluidity, silica is advantageous to the formation of a layer 1 having higher thickness uniformity, and it is possible to make the productivity and dimensional accuracy of the three-dimensional structure 100 particularly excellent.

The average particle diameter of the particles is not particularly limited, but is preferably 1 μm to 25 μm, and more preferably 1 μm to 10 μm. Thus, it is possible to make the mechanical strength of the three-dimensional structure 100 particularly excellent, it is possible to more effectively prevent the occurrence of involuntary unevenness in the manufactured three-dimensional structure 100, and it is possible to make the dimensional accuracy of the three-dimensional structure 100 particularly excellent. Further, when the fluidity of the particle or the fluidity of a three-dimension formation composition is made particularly excellent, it is possible to make the productivity of the three-dimensional structure 100 particularly excellent. In the invention, the average particle diameter refers to a volume average particle diameter, and can be obtained by measuring a dispersion liquid, which is prepared by adding a sample to methanol and dispersing the sample in methanol for 3 minutes using an ultrasonic disperser, using an aperture of 50 μm in a particle size distribution measuring instrument (for example, TA-II, manufactured by Coulter Electronics Inc.) using a coulter counter method.

The Dₘₐₓ of the particle is preferably 3 μm to 40 μm, and more preferably 5 μm to 30 μm. Thus, it is possible to make the mechanical strength of the three-dimensional structure 100 particularly excellent, it is possible to more effectively prevent the occurrence of involuntary unevenness in the manufactured three-dimensional structure 100, and it is possible to make the dimensional accuracy of the three-dimensional structure 100 particularly excellent. Further, when the fluidity of the three-dimension formation composition is made particularly excellent, it is possible to make the productivity of the three-dimensional structure 100 particularly excellent. Moreover, it is possible to more effectively prevent the scattering of light caused by the particles in the surface of the manufactured three-dimensional structure 100.

The particle may have any shape, but, preferably, has a spherical shape. Thus, when the fluidity of the three-dimension formation composition is made particularly excellent, it is possible to make the productivity of the three-dimensional structure 100 particularly excellent. Further, it is possible to more effectively prevent the occurrence of involuntary unevenness in the manufactured three-dimensional structure 100, and it is possible to make the dimensional accuracy of the three-dimensional structure 100 particularly excellent. Moreover, it is possible to more effectively prevent the scattering of light caused by the particles in the surface of the manufactured three-dimensional structure 100.

The content ratio of particles in the three-dimension formation composition is preferably 5 mass % to 80 mass %, and more preferably 10 mass % to 70 mass %. Thus, the fluidity of the three-dimension formation composition can be made sufficiently excellent, and the mechanical strength of the finally obtained three-dimensional structure 100 can be made particularly excellent.

### Binding Resin

The three-dimension formation composition contains a plurality of particles and a binding resin. By allowing the three-dimension formation composition to contain the binding resin, the particles are bound (temporarily fixed) together to effectively prevent the involuntary scattering of the particles. Thus, it is possible to improve the safety of workers or the dimensional accuracy of the manufactured three-dimensional structure 100.

Further, in the above-mentioned unbound particle removal process, the binding resin has a water-soluble functional group whose pKa in water is less than the pH of the removing solution.

Therefore, it is possible to efficiently remove unbound particles in the unbound particle removal process, and thus it is possible to efficiently manufacture a three-dimensional structure.

The pKa of the water-soluble functional group in water is less than the pH of the removing solution, but is preferably 6 or less.

Thus, unbound particles can be more easily removed by the removing solution. Further, it is possible to make the width of the selection of the kind of removing solution wider.

The water-soluble functional group may be used without limitation as long as the pKa of the functional group in water is less than the pH of the removing solution in the unbound particle removal process, but is preferably a carboxyl group or a sulfo group.

Thus, it is possible to more easily perform the removal of unbound particles.

Particularly, in the case of using a removing solution having a pH of 6 to 8 (for example, a neutral removing solution such as water, saline water, or the like), an example of the water-soluble functional group includes a sulfo group.

Specific examples of the binding resin having a sulfo group as the water-soluble functional group include polystyrene sulfonic acid, lignin sulfonic acid, acrylic acid-sulfonic acid copolymers, polyisoprene sulfonic acid, and salts thereof. Among these, the binding resin is preferably lignin sulfonic acid or a salt thereof.

Thus, it is possible to make the binding force of the binding resin more excellent, and it is possible to more efficiently remove unbound particles (unnecessary portion) in the unbound particle removal process.

Further, in the case of using a removing solution having a pH of 8.5 or more (for example, an alkaline removing solution such as ammonia water, lime water, a sodium hydroxide solution, a sodium hydrogen carbonate solution, or the like), examples of the water-soluble functional group include carboxylic acid, phosphoric acid, and a polymer having a phosphoric acid group in a side chain.

Specific examples of the binding resin having a carboxyl group as the water-soluble functional group include a reaction product of an olefin-maleic anhydride copolymer with ammonia, polyacrylic acid, carboxymethyl cellulose, polystyrene carboxylic acid, a acrylamide-acrylic acid copolymer, and alginic acid, and salts thereof.

Thus, it is possible to make the binding force of the binding resin more excellent, and it is possible to more efficiently remove unbound particles (unnecessary portion) in the unbound particle removal process.

Examples of olefin as a monomer component constituting the reaction product of an olefin-maleic anhydride copolymer with ammonia include isobutylene, styrene, and ethylene.

Further, the reaction product of an olefin-maleic anhydride copolymer with ammonia may be a reaction product of a vinyl acetate-maleic anhydride copolymer or a methyl vinyl ether-maleic anhydride copolymer with ammonia.

Further, in the case of using a binding resin having a plurality of water-soluble functional groups (carboxylic groups or sulfo groups) or in the case of using a plurality of kinds of binding resins each having a water-soluble functional group such as a carboxyl group or a sulfo group, it is desirable that the pKa of each of the water-soluble functional groups in water is less than the pH of the removing solution.

It is preferable that, in the above-mentioned binding solution application process, the binding resin has a structure of acid anhydride, and, in the unbound particle removal process, the binding resin has a structure of an ammonium salt of a carboxyl group and has an amide group (—CONH₂).

Thus, the removal of unbound particles can be more easily performed in the unbound particle removal process, and thus the productivity of the three-dimensional structure 100 can be made more excellent, and the affinity of the binding solution 2 having high hydrophobicity, which will be described, to the layer 1 in the binding solution application process can be made more excellent. Further, the repelling of the binding solution 2 on the layer 1 is more effectively prevented, and thus the binding solution 2 can more easily penetrate into the layer 1, thereby more reliably applying the binding solution 2 in a desired pattern. Accordingly, the dimensional accuracy and mechanical strength of the finally obtained three-dimensional structure 100 can more reliably be made particularly excellent. Further, when heat treatment is carried out as post treatment after the unbound particle removal process, ammonia can be suitably eliminated from the binding resin, and thus the hydrophobicity and water resistance of the finally obtained three-dimensional structure 100 can be made excellent.

An example, in which ammonia is eliminated from a reaction product of an isobutylene-maleic anhydride copolymer, as a binding resin having an amide group (—CONH₂) together with an ammonium salt of a carboxyl group, with ammonia by a reaction in a molecule to form a structure of acid anhydride (—COOCO—), is represented by formula below.

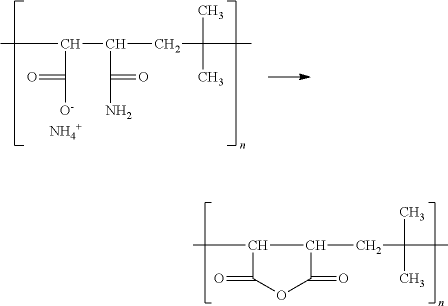

In the formula above, in the binding resin contained in the three-dimension formation composition, it is shown that all of the maleic anhydride, as a monomer constituting a reaction product of an olefin-maleic anhydride copolymer with ammonia, reacts with ammonia. However, the reaction product of an olefin-maleic anhydride copolymer with ammonia, the reaction product being contained in the three-dimension formation composition, may be a product obtained by reacting a part of maleic anhydride, as a monomer constituting the reaction product, with ammonia, and maleic anhydride, as a monomer constituting the reaction product, may hold a structure of acid anhydride without reacting with ammonia.

As described above, the elimination reaction of ammonia, for example, can be suitably processed by heating.

Heating temperature at the time of processing the elimination reaction is not particularly limited, but is preferably 30° C. to 140° C., and more preferably 40° C. to 120° C.

Further, the addition reaction of ammonia, which is a reverse reaction of the above reaction formula, can be suitably processed by bringing a compound having the above acid anhydride structure into contact with ammonia. In this reaction, ammonia may be used as a solution such as an aqueous solution, and may also be used as gas (ammonia gas).

Further, the binding resin has a cyclic chemical structure in the above-mentioned binding solution application process, and thus it is preferable that the cyclic chemical structure of the binding resin is ring-opened in the unbound particle removal process.

Therefore, the removal of unbound particles can be more easily performed in the unbound particle removal process, and thus the productivity of the three-dimensional structure 100 can be made more excellent, and the affinity of the binding solution 2 having high hydrophobicity, which will be described, to the layer 1 in the binding solution application process can be made more excellent. Further, the repelling of the binding solution 2 on the layer 1 is effectively prevented, and thus the binding solution 2 can more easily penetrate into the layer 1, thereby more reliably applying the binding solution 2 in a desired pattern. Accordingly, the dimensional accuracy and mechanical strength of the finally obtained three-dimensional structure 100 can be more reliably made particularly excellent.

It is preferable that the cyclic chemical structure is a five-membered or six-membered cyclic structure.

Thus, the difference in hydrophobicity before and after the ring opening of the cyclic chemical structure can be made more larger, and, from the relationship of steric hindrance, the affinity of the binding solution 2 having high hydrophobicity, which will be described, to the layer 1 in the binding solution application process can be made more excellent, so the binding solution 2 can more easily penetrate into the layer 1, and the removal of unbound particles can be more easily performed in the unbound particle removal process.

The weight average molecular weight of the binding resin in the three-dimension formation composition is not particularly limited, but is preferably 50000 to 200000, and more preferably 70000 to 180000.

Thus, the fixing force of binding (temporarily fixing) particles together is made particularly excellent, so it is possible to more effectively prevent the involuntary scattering of particles, and it is possible to more efficiently perform the removal of unbound particles (unnecessary portion) in the unbound particle removal process. As a result, it is possible to further improve the dimensional accuracy of the three-dimensional structure 100, and it is possible to make the productivity of the three-dimensional structure 100 particularly excellent.

The content ratio of the binding resin in the three-dimension formation composition, based on the volume of particles, is preferably 0.5 vol % to 15 vol %, and more preferably 2 vol % to 5 vol %. In this case, the above-mentioned function of the binding resin can be sufficiently exhibited, and thus the mechanical strength of the three-dimensional structure 100 can be made particularly excellent.

### Solvent

The three-dimension formation composition may contain a solvent in addition to the above-mentioned binding resin and particles. Thus, the fluidity of the three-dimension formation composition becomes particularly excellent, and thus, the productivity of the three-dimensional structure 100 can be particularly improved.

Examples of the solvent constituting the three-dimension formation composition include water; alcoholic solvents, such as methanol, ethanol, and isopropanol; ketone-based solvents, such as methyl ethyl ketone and acetone; glycol ether-based solvents, such as ethylene glycol monoethyl ether and ethylene glycol monobutyl ether; glycol ether acetate-based solvents, such as propylene glycol 1-monomethyl ether 2-acetate and propylene glycol 1-monomethyl ether 2-acetate; polyethylene glycol; and polypropylene glycol. They can be used alone or in a combination of two or more selected therefrom.

Preferably, the three-dimension formation composition contains water. Therefore, the binding resin can be more reliably dissolved, and thus the fluidity of the three-dimension formation composition or the composition uniformity of the layer 1 formed using the three-dimension formation composition can be made particularly excellent. Further, water is easily removed after the formation of the layer 1, and does not negatively influence the three-dimension formation composition even when it remains in the three-dimensional structure 100. Moreover, water is advantageous in terms of safety for the human body and environmental issues.

The content ratio of the solvent in the three-dimension formation composition is preferably 5 mass % to 80 mass %, and more preferably 20 mass % to 80 mass %. Thus, the above-mentioned effects due to containing the solvent can be more remarkably exhibited, and, in the process of manufacturing the three-dimensional structure 100, the solvent can be easily removed in a short time, and thus it is advantageous in terms of improvement in productivity of the three-dimensional structure 100.

In particular, when the three-dimension formation composition contains water as the solvent, the content ratio of water in the three-dimension formation composition is preferably 20 mass % to 85 mass %, and more preferably 20 mass % to 80 mass %. Thus, the above-mentioned effects are more remarkably exhibited.

### Other Components

The three-dimension formation composition may contain components other than the above-mentioned components. Examples of these components include a polymerization initiator, a polymerization accelerator, a dispersant, a binding resin having no water-soluble functional group satisfying the above-mentioned conditions, a penetration enhancer, a wetting agent (humectant), a fixing agent, a fungicide, a preservative, an antioxidant, an ultraviolet absorber, a chelating agent, and a pH adjuster.

Examples of the binding resin having no water-soluble functional group satisfying the above-mentioned conditions include synthetic polymers, such as polyvinyl alcohol (PVA), polyvinyl pyrrolidone (PVP), polycaprolactone diol, polyacrylamide, modified polyamide, polyethylene imine, polyethylene oxide, and random copolymers of ethylene oxide and propylene oxide; natural polymers, such as corn starch, mannan, agar, and dextran; and semi-synthetic polymers, such as hydroxyethyl cellulose and modified starch. They can be used alone or in a combination of two or more selected therefrom.

Among these, when the binding resin is polyvinyl alcohol, the mechanical strength of the three-dimensional structure 100 can be made more excellent. Further, characteristics (for example, solubility in water, and the like) of the binding resin and characteristics (for example, viscosity, fixing force of particles, wettability, and the like) of the three-dimension formation composition can be suitably controlled by adjusting the saponification degree and the polymerization degree, and thus the three-dimension formation composition can be easily handled, thereby making the productivity of the three-dimensional structure 100 particularly excellent. Therefore, it is possible to appropriately cope with the manufacture of various three-dimensional structures 100. In addition, among various resins that can be used as the binding resin, polyvinyl alcohol is inexpensive, and the supply thereof is stable. Therefore, it is possible to stably manufacture the three-dimensional structure 100 while suppressing the production cost thereof.

Meanwhile, when polyvinyl alcohol is used as the binding resin, the above-mentioned excellent effects can be obtained, whereas the water resistance of the finally obtained three-dimensional structure is deteriorated when polyvinyl alcohol is used in manufacturing the three-dimensional structure. In contrast, when the three-dimension formation composition contains a binding resin having a structure of an ammonium salt of a carboxyl group as the binding resin, the water resistance of the three-dimensional structure can be made sufficiently excellent even when the three-dimensional structure further contains polyvinyl alcohol. In other words, in the invention, when using the three-dimension formation composition containing polyvinyl alcohol in addition to a binding resin having a structure of an ammonium salt of a carboxyl group as the binding resin, the water resistance of the finally obtained three-dimensional structure can be made excellent while obtaining the effects due to the use of polyvinyl alcohol. These effects are more remarkably exhibited when a reaction product of an olefin-maleic anhydride copolymer with ammonia is used, among the binding resins each having a structure of an ammonium salt of a carboxyl group.

When the three-dimension formation composition contains polyvinyl alcohol, the saponification degree of the polyvinyl alcohol is preferably 70 to 90. Thus, it is possible to suppress a decrease in solubility of polyvinyl alcohol in water. Therefore, it is possible to more effectively suppress the deterioration of the adhesiveness between adjacent layers 1.

When the three-dimension formation composition contains polyvinyl alcohol, the polymerization degree of the polyvinyl alcohol is preferably 300 to 2000.

Thus, the removal of unbound particles (unnecessary portion) can be more easily performed, and the mechanical strength of the finally obtained three-dimensional structure 100 can be made particularly excellent.

When the three-dimension formation composition contains the binding resin having no water-soluble functional group satisfying the above-mentioned conditions, it is preferable that the content ratio of the binding resin having no water-soluble functional group satisfying the above-mentioned conditions in the three-dimension formation composition is lower than that of the binding resin having a water-soluble functional group satisfying the above-mentioned conditions in the three-dimension formation composition.

Thus, the above-mentioned effects are more remarkably exhibited.

More specifically, the content ratio of the binding resin having no water-soluble functional group satisfying the above-mentioned conditions in the three-dimension formation composition is preferably 15 mass % or less, and more preferably 10 mass % or less.

Particularly, when the three-dimension formation composition contains polyvinyl alcohol, the content ratio of polyvinyl alcohol in the three-dimension formation composition is preferably 0.5 mass % to 10 mass %, and more preferably 1.0 mass % to 8 mass %.

### 3. Binding Solution

Next, the binding solution used in manufacturing the three-dimensional structure of the invention will be described in detail.

The binding solution 2, contains at least a binder.

### Binder

The binder is a component having a function of binding the particles together by curing.

The binder is not particularly limited, but it is preferable that a binder having hydrophobicity (lipophilicity) is used.

Thus, for example, the water resistance of the finally obtained three-dimensional structure 100 can be made more excellent. Further, when ammonia is eliminated from the binding resin contained in the layer 1 coated with the binding solution 2 by the above-mentioned reaction, the affinity of the binding solution 2 to this layer 1 can be made more excellent. Thus, the repelling of the binding solution 2 on the layer 1 at the time of applying the binding solution 2 to the layer 1 is effectively prevented, and thus the binding solution 2 can more easily penetrate into the layer 1. Accordingly, the dimensional accuracy and mechanical strength of the finally obtained three-dimensional structure 100 can be more reliably made particularly excellent. Further, when hydrophobically-treated particles are used, affinity between the binding solution 2 and the particles can be further increased, and the binding solution 2 can suitably penetrate into the pores of the particles when the binding solution 2 is applied to the layer 1. As a result, anchoring effects due to the binder are suitably exhibited, and thus it is possible to make the mechanical strength and water resistance of the finally obtained three-dimensional structure 100 excellent. Further, in the invention, the hydrophobic curable resin may have sufficiently low affinity to water, but, for example, it is preferable that the solubility of the hydrophobic curable resin in water at 25° C. is 1 g/100 g water or less.

Examples of the binder include thermoplastic resins; thermosetting resins; various photocurable resins, such as a visible light-curable resin cured by light in a visible light region, an ultraviolet-curable resin, and an infrared curable resin; and X-ray curable resins. They can be used alone or in a combination of two or more selected therefrom. From the view points of the mechanical strength of the obtained three-dimensional structure 100 or productivity of the three-dimensional structure 100, it is preferable that a curable resin is used as the binder. Further, among various curable resins, from the viewpoints of mechanical strength of the obtained three-dimensional structure 100, productivity of the three-dimensional structure 100, storage stability of the binding solution 2, or treatability under a general visible light environment, it is particularly preferable that an ultraviolet-curable resin (polymerizable compound) is used as the binder. Further, generally, the ultraviolet-curable resin is a material having high hydrophobicity, and is advantageous in manufacturing the three-dimensional structure 100 having excellent water resistance. Further, when ammonia is eliminated from the binding resin contained in the layer 1 coated with the binding solution 2 by the above-mentioned reaction, the affinity of the binding solution 2 to this layer 1 can be made more excellent. Thus, the repelling of the binding solution 2 on the layer 1 at the time of applying the binding solution 2 to the layer 1 is more effectively prevented, and thus the binding solution 2 can more easily penetrate into the layer 1. Accordingly, the dimensional accuracy and mechanical strength of the finally obtained three-dimensional structure 100 can be more reliably made particularly excellent.

As the ultraviolet-curable resin (polymerizable compound), an ultraviolet-curable resin, by which addition polymerization or ring-opening polymerization is initiated by radical species or cationic species resulting from a photopolymerization initiator using ultraviolet irradiation to prepare a polymer, is preferably used. The types of addition polymerization include radical polymerization, cationic polymerization, anionic polymerization, metathesis, and coordination polymerization. The types of ring-opening polymerization include cationic polymerization, anionic polymerization, radical polymerization, metathesis, and coordination polymerization.

As the addition-polymerizable compound, there is exemplified a compound having at least one ethylenically-unsaturated double bond. As the addition-polymerizable compound, a compound having at least one terminal ethylenically-unsaturated bond, and preferably two or more terminal ethylenically-unsaturated bonds can be preferably used.

An ethylenically-unsaturated polymerizable compound has a chemical form of a monofunctional polymerizable compound, a polyfunctional polymerizable compound, or a mixture thereof. Examples of the monofunctional polymerizable compound include unsaturated carboxylic acids (for example, acrylic acid, methacrylic acid, itaconic acid, crotonic acid, isocrotonic acid, and maleic acid), esters thereof, and amides thereof. Examples of the polyfunctional polymerizable compound include esters of unsaturated carboxylic acids and aliphatic polyol compounds, and amides of unsaturated carboxylic acids and aliphatic polyvalent amine compounds.

Further, addition reaction products of unsaturated carboxylic esters or amides having a nucleophilic substituent, such as a hydroxyl group, an amino group, or a mercapto group, with isocyantes or epoxies; and dehydration condensation reaction products of such unsaturated carboxylic esters or amides with carboxylic acids can also be used. Moreover, addition reaction products of unsaturated carboxylic esters or amides having an electrophilic substituent, such as an isocyanate group or an epoxy group, with alcohols, amines, and thiols; and substitution reaction products of unsaturated carboxylic esters or amides having a leaving group, such as a halogen group or a tosyloxy group, with alcohols, amines, and thiols can also be used.

Specific examples of radical polymerizable compounds, which are esters of unsaturated carboxylic acids and aliphatic polyol compounds, include (meth)acrylic esters. Among these (meth)acrylic esters, any one of monofunctional (meth)acrylic esters and polyfunctional (meth)acrylic esters can also be used.

Specific examples of monofunctional (meth)acrylates include tolyloxyethyl (meth)acrylate, phenyloxyethyl (meth)acrylate, cyclohexyl (meth)acrylate, ethyl (meth)acrylate, methyl (meth)acrylate, isobornyl (meth)acrylate, tetrahydrofurfuryl (meth)acrylate, phenoxyethyl acrylate, 2-hydroxy-3-phenoxypropyl acrylate, and 4-hydroxybutyl (meth)acrylate.

Specific examples of difunctional (meth)acrylates include ethylene glycol di(meth)acrylate, triethylene glycol di(meth)acrylate, 1,3-butanediol di(meth)acrylate, tetramethylene glycol di(meth)acrylate, propylene glycol di(meth)acrylate, neopentyl glycol di(meth)acrylate, hexanediol di(meth)acrylate, 1,4-cyclohexanediol di(meth)acrylate, tetraethylene glycol di(meth)acrylate, pentaerythritol di(meth)acrylate, dipentaerythritol di(meth)acrylate, 2-(2-vinyloxyethoxyl)ethyl (meth)acrylate, dipropylene glycol diacrylate, and tripropylene glycol diacrylate.

Specific examples of trifunctional (meth)acrylates include trimethylolpropane tri(meth)acrylate, trimethylolethane tri(meth)acrylate, alkylene oxide-modified tri(meth)acrylate of trimethylolpropane, pentaerythritol tri(meth)acrylate, dipentaerythritol tri(meth)acrylate, trimethylolpropane tri((meth)acryloyloxypropyl) ether, isocyanuric acid alkylene oxide-modified tri(meth)acrylate, propionic acid dipentaerythritol tri(meth)acrylate, tri((meth)acryloyloxyethyl) isocyanurate, hydroxypivalaldehyde-modified dimethylolpropane tri(meth)acrylate, and sorbitol tri(meth)acrylate.

Specific examples of tetrafunctional (meth)acrylates include pentaerythritol tetra(meth)acrylate, sorbitol tetra(meth)acrylate, ditrimethylolpropane tetra(meth)acrylate, propionic acid dipentaerythritol tetra(meth)acrylate, and ethoxylated pentaerythritol tetra(meth)acrylate.

Specific examples of pentafunctional (meth)acrylates include sorbitol penta(meth)acrylate and dipentaerythritol penta(meth)acrylate.

Specific examples of hexafunctional (meth)acrylates include dipentaerythritol hexa(meth)acrylate, sorbitol hexa(meth)acrylate, alkylene oxide-modified hexa(meth)acrylate of phosphazene, and caprolactone-modified dipentaerythritol hexa(meth)acrylate.

Examples of polymerizable compounds other than (meth)acrylates include itaconic acid esters, crotonic acid esters, isocrotonic acid esters, and maleic acid esters.

Examples of itaconic acid esters include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of crotonic acid esters include ethylene glycol dicrotonate, tetramethylene glycol dicrotonate, pentaerythritol dicrotonate, and sorbitol tetracrotonate.

Examples of isocrotonic acid esters include ethylene glycol diisocrotonate, pentaerythritol diisocrotonate, and sorbitol tetraisocrotonate.

Examples of maleic acid esters include ethylene glycol dimaleate, triethylene glycol dimaleate, pentaerythritol dimaleate, and sorbitol tetramaleate.

Specific examples of monomers of amides of unsaturated carboxylic acids and aliphatic polyvalent amine compounds include methylene bis-acrylamide, methylene bis-methacrylamide, 1,6-hexamethylene bis-acrylamide, 1,6-hexamethylene bis-methacrylamide, diethylenetriamine tris-acrylamide, xylylene bisacrylamide, and xylylene bismethacrylamide.

Further, a urethane-based addition-polymerizable compound prepared using the addition reaction of isocyanate and a hydroxyl group is also preferable.

In the invention, a cationic ring-opening polymerizable compound having at least one cyclic ether group such as an epoxy group or an oxetane group in a molecule can be suitably used as an ultraviolet-curable resin (polymerizable compound).

Examples of the cationic polymerizable compound include curable compounds containing a ring-opening polymerizable group. Among these, a curable compound containing a heterocyclic group is particularly preferable. Examples of such curable compounds include epoxy derivatives, oxetane derivatives, tetrahydrofuran derivatives, cyclic lactone derivatives, cyclic carbonate derivatives, cyclic imino ethers such as oxazoline derivatives, and vinyl ethers. Among them, epoxy derivatives, oxetane derivatives, and vinyl ethers are preferable.

Examples of preferable epoxy derivatives include monofunctional glycidyl ethers, polyfunctional glycidyl ethers, monofunctional alicyclic epoxies, and polyfunctional alicyclic epoxies.

Examples of specific compounds of glycidyl ethers include diglycidyl ethers (for example, ethylene glycol diglycidyl ether, bisphenol A diglycidyl ether, and the like), tri- or higher functional glycidyl ethers (for example, trimethylolethane triglycidyl ether, trimethylolpropane triglycidyl ether, glycerol triglycidyl ether, triglycidyl tris-hydroxyethyl isocyanurate, and the like), tetra- or higher functional glycidyl ethers (for example, sorbitol tetraglycidyl ether, pentaerythritol tetraglycidyl ether, polyglycidyl ethers of cresol novolac resins, polyglycidyl ethers of phenolic novolac resin, and the like), alicyclic epoxies, and oxetanes.

As the polymerizable compound, an alicyclic epoxy derivative can be preferably used. The “alicyclic epoxy group” refers to a partial structure in which a double bond of a ring of a cycloalkene group such as a cyclopentene group or a cyclohexene group is epoxidized with a suitable oxidant such as hydrogen peroxide or peracid.

As the alicyclic epoxy compound, polyfunctional alicyclic epoxy compounds having two or more cyclohexene oxide groups or cyclopentene oxide groups in one molecule are preferable. Specific examples of the alicyclic epoxy compound include 4-vinylcyclohexene dioxide, (3,4-epoxycyclohexyl)methyl-3,4-epoxycyclohexyl carboxylate, di-(3,4-epoxycyclohexyl)adipate, di-(3,4-epoxycyclohexylmethyl)adipate, bis-(2,3-epoxy cyclopentyl)ether, di-(2,3-epoxy-6-methylcyclohexyl methyl)adipate, and dicyclopentadiene dioxide.

A general glycidyl compound having an epoxy group, which does not have an alicyclic structure in a molecule, can be used alone or in combination with the above alicyclic epoxy compound.

Examples of the general glycidyl compound include glycidyl ether compounds and glycidyl ester compounds. It is preferable to use glycidyl ether compounds.

Specific examples of glycidyl ether compounds include: aromatic glycidyl ether compounds, such as 1,3-bis(2,3-epoxypropyloxy)benzene, bisphenol A type epoxy resins, bisphenol F type epoxy resins, phenol•novolac type epoxy resins, cresol•ovolac type epoxy resins, and trisphenolmethane type epoxy resin; and aliphatic glycidyl ether compounds, such as 1,4-butanediol glycidyl ether, glycerol triglycidyl ether, propylene glycol diglycidyl ether, and trimethylolpropane triglycidyl ether. Examples of glycidyl esters may include glycidyl esters of a linolenic acid dimer.

As the polymerizable compound, a compound having an oxetanyl group which is a cyclic ether of a four-membered ring (hereinafter, simply referred to as “oxetane compound”) can be used. The oxetanyl group-containing compound is a compound having one or more oxetanyl groups in one molecule.

Particularly, the binding solution 2 preferably contains at least one selected from the group consisting of 2-(2-vinyloxyethoxy)ethyl acrylate, phenoxyethyl acrylate, and dipropylene glycol diacrylate, among the above-mentioned polymerizable compounds.

These polymerizable compounds have particularly excellent affinity to the layer 1 containing the binding resin which is converted to have high hydrophobicity by the above-mentioned elimination reaction of ammonia. Therefore, in the case where the layer 1 coated with the binding solution 2 contains this binding resin, the repelling of the binding solution 2 on the layer 1 at the time of applying the binding solution 2 to the layer 1 is more effectively prevented, and thus the binding solution 2 can more easily penetrate into the layer 1. Accordingly, the dimensional accuracy and mechanical strength of the finally obtained three-dimensional structure 100 can be made particularly excellent.

The content ratio of the binder in the binding solution 2 is preferably 80 mass % or more, and more preferably 85 mass % or more. In this case, it is possible to make the mechanical strength of the finally obtained three-dimensional structure 100 particularly excellent. Other components

The binding solution 2 may contain other components in addition to the above-mentioned components. Examples of these components include various colorants such as pigments and dyes; dispersants; surfactants; polymerization initiators; polymerization accelerators; solvents; penetration enhancers; wetting agents (humectants); fixing agents; fungicides; preservatives; antioxidants; ultraviolet absorbers; chelating agents; pH adjusters; thickeners; fillers; aggregation inhibitors; and defoamers.

Particularly, when the binding solution 2 contains the colorant, it is possible to obtain a three-dimensional structure 100 colored in a color corresponding to the color of the colorant.

Particularly, when the binding solution 2 contains pigment as the colorant, it is possible to make the light resistance of the binding solution 2 or the three-dimensional structure 100 good. As the pigment, both inorganic pigments and organic pigments can be used.

Examples of inorganic pigments include carbon blacks (C.I. Pigment Black 7) such as furnace black, lamp black, acetylene black, and channel black; iron oxides; titanium oxides; and the like. They can be used alone or in a combination of two or more selected therefrom.

Among these inorganic pigments, in order to exhibit preferable white color, titanium oxide is preferable.

Examples of organic pigments include azo pigments such as insoluble azo pigments, condensed azo pigments, azo lakes, and chelate azo pigments; polycyclic pigments such as phthalocyanine pigments, perylene and perinone pigments, anthraquinone pigments, quinacridone pigments, dioxane pigments, thioindigo pigments, isoindolinone pigments, and quinophthalone pigments; dye chelates (for example, basic dye chelates, acidic dye chelates, and the like); staining lakes (basic dye lakes, acidic dye lakes); nitro pigments; nitroso pigments; aniline blacks; and daylight fluorescent pigments. They can be used alone or in a combination of two or more selected therefrom.

When the binding solution 2 contains a colorant, the content ratio of the colorant in the binding solution 2 is preferably 1 mass % to 20 mass %. Thus, particularly excellent hiding properties and color reproducibility are obtained.

Particularly, when the binding solution 2 contains titanium oxide as the colorant, the content ratio of titanium oxide in the binding solution 2 is preferably 12 mass % to 24 mass %, and more preferably 14 mass % to 20 mass %. Thus, particularly excellent hiding properties and sedimentation recovery properties are obtained.

When the binding solution 2 contains a dispersant in addition to a pigment, the dispersibility of the pigment can be further improved. As a result, it is possible to more effectively suppress the partial reduction in mechanical strength due to the bias of the pigment.

The dispersant is not particularly limited, but examples thereof include dispersants, such as a polymer dispersant, generally used in preparing a pigment dispersion liquid. Specific examples of the polymer dispersants include polymer dispersants containing one or more of polyoxyalkylene polyalkylene polyamine, vinyl-based polymers and copolymers, acrylic-based polymers and copolymers, polyesters, polyamides, polyimides, polyurethanes, amino-based polymers, silicon-containing polymers, sulfur-containing polymers, fluorinated polymers, and epoxy resins, as main components thereof.

When the binding solution 2 contains a surfactant, the penetrability into the layer 1 and the abrasion resistance of the three-dimensional structure 100 can be improved. The surfactant is not particularly limited, but examples thereof include silicone-based surfactants such as polyester-modified silicone, and polyether-modified silicone. Among these, polyether-modified polydimethylsiloxane or polyester-modified polydimethylsiloxane is preferably used.

The binding solution 2 may contain a solvent. Thus, the viscosity of the binding solution 2 can be suitably adjusted, and the discharge stability of the binding solution 2 by an ink jet method can be made particularly excellent even when the binding solution 2 contains a component having high viscosity.

Examples of the solvent include (poly)alkylene glycol monoalkyl ethers, such as ethylene glycol monomethyl ether, ethylene glycol monoethyl ether, propylene glycol monomethyl ether, and propylene glycol monoethyl ether; acetic acid esters, such as ethyl acetate, n-propyl acetate, iso-propyl acetate, n-butyl acetate, and iso-butyl acetate; aromatic hydrocarbons, such as benzene, toluene, and xylene; ketones, such as methyl ethyl ketone, acetone, methyl isobutyl ketone, ethyl-n-butyl ketone, diisopropyl ketone, and acetylacetone; alcohols, such as ethanol, propanol, and butanol. They can be used alone or in a combination of two or more selected therefrom.

The viscosity of the binding solution 2 is preferably 10 mPa·s to 25 mPa·s, and more preferably 15 mPa·s to 20 mPa·s. Thus, the discharge stability of the binding solution 2 by an ink jet method can be made particularly excellent. In the present specification, viscosity refers to a value measured at 25° C. using an E-type viscometer (for example, VISCONIC ELD, manufactured by TOKYO KEIKI INC.), unless conditions are otherwise designated.

Meanwhile, in the manufacture of the three-dimensional structure 100, a plurality of kinds of binding solutions 2 may be used.

For example, a binding solution 2 (color ink) containing a colorant and a binding solution 2 (clear ink) containing no colorant may be used. Thus, for example, for the appearance of the three-dimensional structure 100, the binding solution 2 containing a colorant may be used as a binding solution 2 applied to the region influencing color tone, and, for the appearance of the three-dimensional structure 100, the binding solution 2 containing no colorant may be used as a binding solution 2 applied to the region not influencing color tone. Further, in the finally obtained three-dimensional structure 100, a plurality of kinds of binding solutions 2 may be used in combination with each other such that the region (coating layer) formed using the binding solution 2 containing no colorant is provided on the outer surface of the region formed using the binding solution 2 containing a colorant.

For example, a plurality of kinds of binding solutions 2 containing colorants having different compositions from each other may be used. Thus, a wide color reproducing area that can be expressed can be realized by the combination of these binding solutions 2.

When the plurality of kinds of binding solutions 2 are used, it is preferable that at least a indigo-violet (cyan) binding solution 2, a red-violet (magenta) binding solution 2, and a yellow binding solution 2 are used. Thus, a wider color reproducing area that can be expressed can be realized by the combination of these binding solutions 2.

Further, for example, the following effects are obtained by the combination of a white binding solution 2 and another colored binding solution 2. That is, the finally obtained three-dimensional structure 100 can have a first area on which a white binding solution 2 is applied, and a second area which overlaps with the first area and is provided outside the first area and on which a binding solution 2 having a color other than white color is applied. Thus, the first area on which a white binding solution 2 is applied can exhibit hiding properties, and the color saturation of the three-dimensional structure 100 can be enhanced.

### 4. Three-Dimensional Structure

The three-dimensional structure of the invention can be manufactured using the above-mentioned method of manufacturing a three-dimensional structure. Thus, it is possible to provide a high-quality three-dimensional structure.

Applications of the three-dimensional structure of the invention are not particularly limited, but examples thereof include appreciated and exhibited objects such as dolls and figures; and medical instruments such as implants; and the like.

In addition, the three-dimensional structure of the invention may be applied to prototypes, mass-produced products, made-to-order goods, and the like.

Although preferred embodiments of the invention have been described, the invention is not limited thereto.

More specifically, for example, it has been described in the aforementioned embodiment that, in addition to the layer forming process and the binding solution application process, the curing process is also repeated in conjunction with the layer forming process and the binding solution application process. However, the curing process may not be repeated. For example, the curing process may be carried out collectively after forming a laminate having a plurality of layers that are not cured.

In the method of manufacturing a three-dimensional structure according to the invention, if necessary, a pre-treatment process, an intermediate treatment process, or a post-treatment process may be carried out.

As an example of the pre-treatment process, a process of cleaning a support (stage) is exemplified.

As the intermediate treatment process, for example, a treatment of removing the solvent contained in the layer may be performed between the layer forming process and the binding solution application process. Thus, the productivity of the three-dimensional structure can be made more excellent. As the treatment of removing the solvent contained in the layer, heat treatment, decompression treatment, and the like are exemplified, but heat treatment is preferable. Accordingly, it is possible to efficiently remove the solvent while preventing the increase in size of a three-dimensional structure manufacturing apparatus.

Further, when heat treatment is performed, in case that the binding resin contained in the layer has a chemical structure of an ammonium salt or the like, the elimination reaction of ammonia from the binding resin can be efficiently processed, and thus the above-mentioned effects can be efficiently obtained.

Examples of the post-treatment process include a cleaning process, a shape adjusting process of performing deburring or the like, a coloring process, a process of forming a covering layer, and an ultraviolet curable resin curing completion process of performing light irradiation treatment or heat treatment for reliably curing an uncured ultraviolet curable resin.

Further, for example, when the binding resin contained in the structure obtained after the unbound particle removal process has a structure of a salt, as the post treatment, a treatment of removing counter ions from the binder resin may be performed. More specifically, for example, when the binding resin has a structure of an ammonium salt of carboxylic acid, a treatment of removing ammonia may be performed. Thus, the water resistance and durability of the finally obtained three-dimensional structure can be made more excellent. Such a treatment may be performed by any method, but, when the binding resin has a structure of an ammonium salt of carboxylic acid, this treatment is preferably performed by heat treatment. In this case, ammonia can be efficiently removed from the three-dimensional structure, and, even when a liquid component, such as a removing solution, remains in the three-dimensional structure, this liquid component can be efficiently removed. When such a heat treatment is performed, heating temperature at the time of the heat treatment is not particularly limited, but is preferably 30° C. to 140° C., and more preferably 40° C. to 120° C. In this case, it is possible to efficiently remove ammonia from the three-dimensional structure while effectively preventing the involuntary denaturation and degradation of the constituent material of the three-dimensional structure.

Further, it has been described in the aforementioned embodiment that the binding solution is applied to all of the layers. However, a layer on which the binding solution is not applied may exist. For example, the binding solution may not be applied to the layer formed on the surface of a support (stage), thus allowing this layer to function as a sacrificial layer.

Moreover, in the aforementioned embodiment, the case of performing the binding solution application process using an ink jet method has been mainly described. However, the binding solution application process may be performed using other methods (for example, other printing methods).

Moreover, in the aforementioned embodiment, the case of the binding solution containing a curable resin (polymerizable compound) has been mainly described. However, the binding resin, for example, may contain a thermoplastic resin instead of a curable resin (polymerizable compound). Even in this case, when the thermoplastic resin is changed from a molten state to a solid state or is changed to a solid state by removing the solvent (solvent dissolving the thermoplastic resin) contained in the binding solution, a binding portion can be formed, and thus it possible to obtain the same effect as described above.

Moreover, it has been typically described in the aforementioned embodiment that the finally obtained three-dimensional structure has the binding portion formed using the binding solution. However, in the invention, the finally obtained three-dimensional structure may not contain a binder due to the binding solution, and, for example, may be a sintered body in which the particles are bound together by laminating a plurality of layers and then performing delipidation and sintering.

### EXAMPLES

Hereinafter, the invention will be described in more detail with reference to the following specific Examples, but the invention is not limited to these Examples. In the following description, particularly, it is assumed that treatment showing no temperature condition is performed at room temperature (25° C.). Further, in the case where a temperature condition is not shown even under various measurement conditions, it is assumed that the measured values are values measured at room temperature (25° C.)

### 1. Preparation of Three-Dimension Formation Composition Example 1

First, 35 parts by mass of porous silica particles (average particle diameter: 2.6 μm, Dmax: 10 μm, porosity: 80%, average pore diameter: 60 nm); 2 parts by mass of a reaction product (weight average molecular weight: 50000) of an isobutylene-maleic anhydride copolymer with ammonia, as a binding resin; 1 part by mass of polyvinyl alcohol (Saponification degree: 87, polymerization degree: 500), as a binding resin; and 62 parts by mass of water, as a solvent, were mixed, so as to obtain a three-dimension formation composition.

### 2. Manufacture of Three-Dimensional Structure

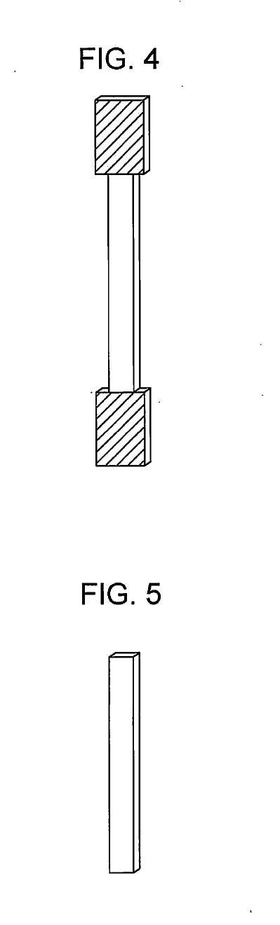

The three-dimensional structure A (total length: 200 mm) having a shape shown in FIG. 4, that is, having a dumbbell shape based on JIS K 7139: 1996 (ISO 3167: 1993), and the three-dimensional structure B having a shape shown in FIG. 5, that is, having a cuboid shape of 4 mm (thickness)×10 mm (width)×80 mm (length) were manufactured as follows using the obtained three-dimension formation composition.

First, a layer (thickness: 20 μm) was formed on the surface of a support (stage) using the three-dimension formation composition and a squeegee method (layer forming process).

Next, the formed layer was heat-treated.

The heat treatment of the layer was conducted by blowing hot air for each site of the layer under conditions of a heating temperature of 60° C. and heating time of 120 seconds. The wind speed of hot air in the heat treatment was 7.5 m/s.

Next, a binding solution was applied to the heat-treated layer in a predetermined pattern by an ink jet method (binding solution application process). As the binding solution, a binding solution having the following composition and a viscosity of 18 mPa·s at 25° C. was used. Polymerizable compound
2-(2-vinyloxyethoxyl)ethyl acrylate: 32 mass %
phenoxyethyl acrylate: 10 mass %
2-hydroxy-3-phenoxypropyl acrylate: 13.75 mass %
dipropylene glycol diacrylate: 15 mass %
4-hydroxybutyl acrylate: 20 mass % Polymerization initiator
bis(2,4,6-trimethylbenzoyl)-phenylphosphine oxide: 5 mass %
2,4,6-trimethylbenzoyl-diphenyl-phosphine oxide: 4 mass %

### Fluorescent Whitening Agent (Sensitizer)

1,4-bis-(benzoxazole-2-yl)naphthalene: 0.25 mass %

Next, the layer was irradiated with ultraviolet rays to cure the binder contained in the layer (curing process).

Thereafter, a series of processes of the layer forming process to the curing process were repeated such that a plurality of layers were laminated while changing the pattern of the applied binding solution depending on the shape of the three-dimensional structure to be manufactured.

Thereafter, the laminate obtained in this way was dipped into ammonia water, as a removing solution having a ph of 9 at 60° C., and ultrasonic vibration was applied thereto to remove an unnecessary portion (unbound particles) containing the particles not bound by the binder in each of the layers (unbound particle removal process). Then, the laminate was washed with water, and was heat-treated under conditions of a heating temperature of 60° C. and heating time of 20 minutes. The heat treatment of the laminate was conducted by blowing hot air. The wind speed of hot air in the heat treatment was 7.5 m/s.

In this way, the three-dimensional structure A and the three-dimensional structure B were obtained two by two, respectively.

### Examples 2 to 8

Three-dimension formation compositions and three-dimensional structures were respectively manufactured in the same manner as in Example 1, except that the configuration of each of the three-dimension formation compositions was changed as shown in Table 1 by changing the kinds of raw materials used in preparing the three-dimension formation composition and the composition ratio of each of the components, and except that the treatment conditions in the unbound particle removal process were changed as shown in Table 1.

### Comparative Example 1

A three-dimension formation composition and a three-dimensional structure were manufactured in the same manner as in the above Example, except that components used in preparing the three-dimension formation composition and the composition ratio of each of the components were changed as shown in Table 1.

### Comparative Example 2

A three-dimensional structure was manufactured in the same manner as in the above Example, except that, in the unbound particle removal process, carbonated water having a pH of 4.5 was used as the removing solution.

The configurations of the three-dimension formation compositions of Examples and Comparative Examples and the treatment conditions in the unbound particle removal process are summarized in Table 1. In Table 1, silica is expressed by “SiO₂”, alumina is expressed by “Al₂O₃”, calcium carbonate is expressed by “CaCO₃”, titanium dioxide is expressed by “TiO₂”, a reaction product of an isobutylene-maleic anhydride copolymer with ammonia is expressed by “IBMA”, a polyacrylic acid ammonium salt is expressed by “PAAm”, an ammonium salt of carboxymethyl cellulose is expressed by “CMCAm”, a polystyrene carboxylic acid ammonium salt is expressed by “PSAc”, an ammonium salt of an acrylamide-acrylic acid copolymer is expressed by “AAAAc”, an alginic acid ammonium salt is expressed by “AlgAm”, polystyrene sulfonic acid is expressed by “PSSAm”, lignin sulfonic acid is expressed by “LigSAm”, polyvinyl alcohol (saponification degree: 87, polymerization degree: 500) is expressed by “PVA”, and polyvinyl pyrrolidone (weight average molecular weight: 50000) is expressed by “PVP”.

Further, in Table 1, the binding resin having a water-soluble functional group of predetermined pKa is expressed by “predetermined binding resin, and the binding resin not having a water-soluble functional group of predetermined pKa is expressed by “other binding resin”.

Further, the content ratio of the binding resin having a water-soluble functional group of predetermined pKa in the three-dimension formation composition, all in each of Examples, was a value in the range of 2 vol % to 5 vol %, based on the volume of particles. Further, the binding resin contained in the three-dimension formation composition of each of Examples had a solubility of 20 g/100 g water or more in water at 25° C.

TABLE 1

| | composition of three-dimension formation composition | | | | | | | |
|---|---|---|---|---|---|---|---|---|
| | | | Water-based | | Predetermined binding resin | | | |
| | Particle | | solvent | | | Weight | | pKa of water-soluble |
| | | Content ratio | | Content ratio | | average | Content ratio | functional group in water in |
| | | (parts by | | (parts by | | molecular | (parts by | unbound particle removal |
| | Kind | mass) | Kind | mass) | Kind | weight | mass) | process |
| Ex. 1 | SiO₂ | 35 | water | 62 | IBMA | 50000 | 2 | 5.8 |
| Ex. 2 | SiO₂ | 35 | water | 62 | PAAm | 150000 | 3 | 5.8 |
| Ex. 3 | SiO₂ | 35 | water | 62 | CMCAm | 150000 | 3 | 5.0 |
| Ex. 4 | SiO₂ | 35 | water | 62 | PSAc | 50000 | 3 | 5.0 |
| Ex. 5 | SiO₂ | 35 | water | 62 | AAAAc | 100000 | 3 | 5.5 |
| Ex. 6 | Al₂O₃ | 80 | water | 18 | AlgAm | 180000 | 2 | 3.5 |
| Ex. 7 | CaCO₃ | 80 | water | 18 | PSSAm | 200000 | 2 | 2.8 |
| Ex. 8 | TiO₂ | 80 | water | 18 | LigSAm | 120000 | 2 | 2.8 |
| Comp. | SiO₂ | 35 | water | 62 | — | — | — | — |
| Ex. 1 | | | | | | | | |
| Comp. | SiO₂ | 35 | water | 62 | IBMA | 50000 | 2 | 5.8 |
| Ex. 2 | | | | | | | | |

| | composition of | | | |
|---|---|---|---|---|
| | three-dimension | | | |
| | formation | | | |
| | composition | | Treatment conditions | |
| | Other binding | | of unbound | |
| | resins | | particle removal process | |
| | | Content ratio | pH of | Temperature of |
| | | (parts by | removing | removing solution |
| | Kind | mass) | solution | (° C.) |
| Ex. 1 | PVA | 1 | 9 (ammonia | 60 |
| | | | water) | |
| Ex. 2 | — | — | 9 (ammonia | 60 |
| | | | water) | |
| Ex. 3 | — | — | 8 (ammonia | 60 |
| | | | water) | |
| Ex. 4 | — | — | 9 (ammonia | 60 |
| | | | water) | |
| Ex. 5 | — | — | 7 (pure water) | 60 |
| Ex. 6 | — | — | 9 (ammonia | 60 |
| | | | water) | |
| Ex. 7 | — | — | 9 (ammonia | 60 |
| | | | water) | |
| Ex. 8 | — | — | 4.5 | 60 |
| | | | (carbonated | |
| | | | water) | |
| Comp. | PVP | 3 | 9 (ammonia | 60 |
| Ex. 1 | | | water) | |
| Comp. | PVA | 1 | 4.5 | 60 |
| Ex. 2 | | | (carbonated | |
| | | | water) | |

### 3. Evaluation

### 3.1. Productivity of Three-Dimensional Structure

The productivity of the three-dimensional structure of each of Examples and Comparative Examples was evaluated according to the following criteria.

A: Unbound particles can be very efficiently removed, and thus the productivity of the three-dimensional structure is very excellent.

B: Unbound particles can be efficiently removed, and thus the productivity of the three-dimensional structure is excellent.

C: Unbound particles can be sufficiently removed, and thus the productivity of the three-dimensional structure is good.

D: It is difficult to sufficiently remove unbound particles, and thus the productivity of the three-dimensional structure is slightly poor.

E: It is difficult to sufficiently remove unbound particles, and thus the productivity of the three-dimensional structure is poor.

### 3.2. Dimensional Accuracy

The thickness, width, and length of the three-dimensional structure B of each of Examples and Comparative Examples were measured, the deviation amounts from designed values were determined, and then the dimensional accuracy thereof was evaluated according to the following criteria.

A: deviation amount from designed value in thickness, width, and length is less than 1.0% with respect to the maximum deviation amount.

B: deviation amount from designed value in thickness, width, and length is 1.0% to less than 2.0% with respect to the maximum deviation amount.

C: deviation amount from designed value in thickness, width, and length is 2.0% to less than 4.0% with respect to the maximum deviation amount.

D: deviation amount from designed value in thickness, width, and length is 4.0% to less than 7.0% with respect to the maximum deviation amount.

E: deviation amount from designed value in thickness, width, and length is 7.0% or more with respect to the maximum deviation amount.

### 3.3. Tensile Strength and Tensile Elastic Modulus

The tensile strength and tensile elastic modulus of the three-dimensional structure A of each of Examples and Comparative Examples were measured under the conditions of a tensile yield stress of 50 mm/min and a tensile elastic modulus of 1 mm/min based on JIS K 7161: 1994 (ISO 527: 1993). The tensile strength and tensile elastic modulus thereof were evaluated according to the following criteria.

### Tensile Strength

A: tensile strength of 38 MPa or more

B: tensile strength of 33 MPa to less than 38 MPa

C: tensile strength of 23 MPa to less than 33 MPa

D: tensile strength of 13 MPa to less than 23 MPa

E: tensile strength of less than 13 MPa

### Tensile Elastic Modulus

A: tensile elastic modulus of 1.6 GPa or more

B: tensile elastic modulus of 1.4 GPa to less than 1.6 GPa

C: tensile elastic modulus of 1.2 GPa to less than 1.4 GPa

D: tensile elastic modulus of 1.0 GPa to less than 1.2 GPa

E: tensile elastic modulus of less than 1.0 GPa

### 3.4. Bending Strength and Bending Elastic Modulus

The bending strength and bending elastic modulus of the three-dimensional structure B of each of Examples and Comparative Examples were measured under the conditions of a distance between supporting points of 64 mm and a testing speed of 2 mm/min based on JIS K 7171: 1994 (ISO 178: 1993). The bending strength and bending elastic modulus thereof were evaluated according to the following criteria.

### Bending Strength

A: bending strength of 68 MPa or more

B: bending strength of 63 MPa to less than 68 MPa

C: bending strength of 48 MPa to less than 63 MPa

D: bending strength of 33 MPa to less than 48 MPa

E: bending strength of less than 33 MPa

### Bending Elastic Modulus

A: bending elastic modulus of 2.5 GPa or more

B: bending elastic modulus of 2.4 GPa to less than 2.5 GPa

C: bending elastic modulus of 2.3 GPa to less than 2.4 GPa

D: bending elastic modulus of 2.2 GPa to less than 2.3 GPa

E: bending elastic modulus of less than 2.2 GPa

### 3.5. Water Resistance

In the three-dimensional structure B of each of Examples and Comparative Examples, the mass W₁(g) immediately after the manufacture thereof was measured, and then the three-dimensional structure B was dipped into water and left for 24 hours. Thereafter, the three-dimensional structure B was taken out from water, the water adhered thereto was sufficiently removed, and then the mass W₂(g) of the three-dimensional structure B was measured.

The mass increase rate ([(W₂−W₁)/W₁]×100) of the three-dimensional structure B was determined from W₁ and W₂ values, and the water resistance thereof was evaluated according to the following criteria. It can be inferred that the smaller the mass increase rate, the more excellent the water resistance.

A: mass increase rate of less than 5%

B: mass increase rate of 5% to less than 10%

C: mass increase rate of 10% to less than 20%

D: mass increase rate of 20% to less than 30%

E: mass increase rate of 30% or more

These results are summarized in Table 2.

TABLE 2

| | Productivity of | | | Tensile | | Bending | |
|---|---|---|---|---|---|---|---|
| | three-dimensional | Dimensional | Tensile | elastic | Bending | elastic | Water |
| | structure | accuracy | strength | modulus | strength | modulus | resistance |
| Ex. 1 | A | B | B | B | B | B | A |
| Ex. 2 | A | A | A | A | A | A | A |
| Ex. 3 | A | A | A | A | A | A | B |
| Ex. 4 | A | A | A | A | A | A | A |
| Ex. 5 | B | A | A | A | A | A | C |
| Ex. 6 | A | B | B | B | B | B | A |
| Ex. 7 | A | B | B | B | B | B | A |
| Ex. 8 | C | B | B | B | B | B | C |
| Comp. | E | E | E | E | E | E | E |
| Ex. 1 | | | | | | | |
| Comp. | E | E | E | E | E | E | E |
| Ex. 2 | | | | | | | |

As apparent from Table 2, in the invention, three-dimensional structures could be manufactured with the excellent productivity. Further, three-dimensional structures having excellent dimensional accuracy and excellent mechanical strength could be obtained. In contrast, in Comparative Examples, satisfactory results could not be obtained.

The entire disclosure of Japanese Patent Application No.: 2014-137111, filed Jul. 2, 2014 and 2015-080920, filed Apr. 10, 2015 are expressly incorporated by reference herein.

What is claimed is:

1. A method of manufacturing a three-dimensional structure, in which the three-dimensional structure is manufactured by laminating a layer, the method comprising:
forming the layer using a three-dimension formation composition containing particles, a binding resin, and a solvent;
applying a binding solution containing a binder to the layer; and
removing the particles, which are not bound by the binder, using a removing solution after repeating the forming of the layer and the applying of the binding solution,
wherein, in the removing of the unbound particles, the binding resin has a water-soluble functional group whose pKa in water is less than the pH of the removing solution.

2. The method of manufacturing a three-dimensional structure according to claim 1,
wherein the pKa of the water-soluble functional group in water is 6 or less.

3. The method of manufacturing a three-dimensional structure according to claim 1,
wherein the water-soluble functional group is a carboxyl group or a sulfo group.

4. The method of manufacturing a three-dimensional structure according to claim 1,
wherein the binding resin having a carboxyl group as the water-soluble functional group contains one or more selected from the group consisting of a reaction product of an olefin-maleic anhydride copolymer with ammonia, polyacrylic acid, carboxymethyl cellulose, polystyrene carboxylic acid, a acrylamide-acrylic acid copolymer, and alginic acid, and salts thereof.

5. The method of manufacturing a three-dimensional structure according to claim 1,
wherein the binding resin having a sulfo group as the water-soluble functional group contains lignin sulfonic acid or a salt thereof.

6. The method of manufacturing a three-dimensional structure according to claim 1,
wherein the weight average molecular weight of the binding resin in the three-dimension formation composition is 50000 to 200000.

7. The method of manufacturing a three-dimensional structure according to claim 1,
wherein, in the applying of the binding solution, the binding resin has a structure of acid anhydride, and, in the removing of the unbound particles, the binding resin has a structure of an ammonium salt of a carboxyl group and has an amide group (—CONH₂).

8. The method of manufacturing a three-dimensional structure according to claim 1,
wherein, in the applying of the binding solution, the binding resin has a cyclic chemical structure, and, in the removing of the unbound particles, the cyclic chemical structure of the binding resin is ring-opened.

9. The method of manufacturing a three-dimensional structure according to claim 8,
wherein the cyclic chemical structure is a five-membered or six-membered cyclic structure.

10. A three-dimensional structure, which is manufactured by the method of manufacturing a three-dimensional structure according to claim 1.

11. A three-dimensional structure, which is manufactured by the method of manufacturing a three-dimensional structure according to claim 2.

12. A three-dimensional structure, which is manufactured by the method of manufacturing a three-dimensional structure according to claim 3.

13. A three-dimensional structure, which is manufactured by the method of manufacturing a three-dimensional structure according to claim 4.

14. A three-dimensional structure, which is manufactured by the method of manufacturing a three-dimensional structure according to claim 5.

15. A three-dimensional structure, which is manufactured by the method of manufacturing a three-dimensional structure according to claim 6.

16. A three-dimensional structure, which is manufactured by the method of manufacturing a three-dimensional structure according to claim 7.

17. A three-dimensional structure, which is manufactured by the method of manufacturing a three-dimensional structure according to claim 8.

18. A three-dimensional structure, which is manufactured by the method of manufacturing a three-dimensional structure according to claim 9.

19. A three-dimension formation composition, which is used in the method of manufacturing a three-dimensional structure according to claim 1, the composition comprising:
particles;
a binding resin; and
a solvent,
wherein, in the removing of the unbound particles, the binding resin has a water-soluble functional group whose pKa in water is less than the pH of the removing solution.

20. A three-dimension formation composition, which is used in the method of manufacturing a three-dimensional structure according to claim 2, the composition comprising:
particles;
a binding resin; and
a solvent,
wherein, in the removing of the unbound particles, the binding resin has a water-soluble functional group whose pKa in water is less than the pH of the removing solution.
